(19) United States
(12) Patent Application Publication
(10) Pub. No.: US 2004/0193901 A1
(43) Pub. Date: Sep. 30, 2004

(54) Dynamic configuration of patient tags and masking types while de-identifying patient data during image export from PACS diagnostic workstation

(75) Inventor: Aavishkar Bharara, Bangalore (IN)

Correspondence Address: JOSEPH S. HEINO, ESQ., 111 E. KILBOURN AVENUE, SUITE 1400, MILWAUKEE, WI, 53202, US

(73) Assignee: GE Medical Systems Global Company, LLC, Waukesha, WI

(21) Appl. No.: 10/401,219

(22) Filed: Mar. 27, 2003

(51) Int. Cl. H04L 9/00; G06F 17/60

(52) U.S. Cl. 713/193; 705/3

(57) ABSTRACT

A method and system for doing patient de-identification provides that various DICOM tags that need to be masked or encrypted can be easily configured in the system parameters of a healthcare provider's CAS. Whenever the user selects to export any image outside PACS, the CAS is looked for to check if the system forces de-identification or gives the user the choice for de-identification. If the de-identification needs to be done forcefully, then all the configured DICOM tags are extracted from the CAS and stored in the application for performance enhancement. The application then applies the extracted logic while exporting all the selected images and masks all DICOM tags listed in the CAS to be masked. If the system does not enforce de-identification, then the CAS returns only the list of the DICOM tags to be exported, which are then cached in the application for performance purposes. The user is then prompted to do patient de-identification manually and is also prompted for the choice of the masking for the selected DICOM tags. The images are then exported by masking the listed DICOM tags and keeping the rest of the DICOM tags as if they are on the exported image, in any format.

### BACKGROUND OF THE INVENTION

This invention relates to integrated systems of digital products and technology that allow for the acquisition, storage, retrieval and display of radiographic images. It also relates to systems for acquiring, storing, retrieving and displaying patient information and data that is associated with such radiographic images. More particularly, it relates to a method and a system for the dynamic configuration for patient tags and masking types while de-identifying patient data during image export from a picture archiving and communication system diagnostic workstation.

The acronym, PACS (Picture Archiving and Communication System), is an industry term for an integrated system of equipment and software that permits radiographic images, such as x-rays, ultrasound computerized tomography (CT) scans, magnetic resonance (MR) imaging, nuclear medicine (NM) imaging, positron emission computed tomography (PET), etc., to be electronically acquired, stored, retrieved, displayed and transmitted for viewing by medical personnel. Computed radiography (CR) and direct radiography (DR) are becoming prominent filmless methods for capturing image data that is generated during a radiography procedure. A CR cassette contains an imaging plate that is exposed to radiation during a radiographic study. The radiation ionizes the molecular material in proportion to the amount of radiation imparted on the imaging plate. This molecular material stores that energy until the cassette is placed into a CR reader. The CR reader exposes the cassette to an electromagnetic pulse that causes the molecular material to release the stored energy in the form of light. This light is measured by the CR reader for each pixel area on the plate and is converted to a digital format that can be stored in a computer format or filed on the PACS equipment. Similarly, the DR acquisition system replaces a conventional cassette with a solid-state receptor. When the receptor is exposed to a radiation field, the radiation ionizes the solid-state detector in proportion to the amount of radiation imparted on the receptor. The receptor outputs an electrical voltage for each pixel area on the receptor that forms a digital format that can be stored in the PACS equipment as well. All such images can be viewed on the monitor of a diagnostic workstation accessible to authorized users or transmitted to a different workstation for review.

In addition to the images that can be viewed, it is necessary to be able to associate certain patient information, such as patient name, sex, age, etc., with such images. However, due to concerns for patient confidentiality, it is necessary to maintain the security of that patient information as it is generated, stored and transmitted from one healthcare facility or provider to another.

The Health Insurance Portability And Accountability Act (HIPAA) currently requires healthcare organizations using electronic media to store patient data in such a way that it ensures that unauthorized access to this patient information is prevented. This includes access to the patient information while viewing images at the diagnostic workstation, while exporting the images to a directory on the local system or to a mail recipient through the workstation.

PACS, which was originally founded in government and academic settings, has enjoyed accelerated growth due to the advancement of communication standards, decreased costs and phased implementation methods. Additionally, significantly increased image storage requirements such as those experienced in CT and MR technologies have had a major impact on cost justification for PACS installations. Accordingly, PACS is now a well-known technology that is available to primary care facilities, hospitals, medical centers and other healthcare providers.

The key components of PACS are modality interfaces, a network backbone, a database management system, an image management system, a long-term archive and diagnostic and clinical workstations. The database management system is a software application that collects, stores and processes non-image data associated with stored images. The long-term archive is used to indicate the logical and physical storage of images over a long period of time. Such storage may be centralized or distributed and may exist in many different media formats. Storage may also be termed primary, secondary or tertiary, depending upon the length of storage time required. Primary storage is short term, usually 30 to 120 days. Secondary storage is an intermediate length of storage, usually about one year. Tertiary storage retains images for a period of time necessary to meet legal requirements.

PACS includes interfaces with the hospital information system (HIS) and radiology information system (RIS). The HIS is application software that manages the business of the hospital or other healthcare provider. The RIS is application software that manages the business of a radiology department contained within that hospital or that is associated with it. A web server is included which allows access to the internet The web server connects to the PACS infrastructure through a TCP/IP connection and provides access, via the internet, through a secured channel allowing medical staff the ability to display radiologic images in their offices or clinics without investing significantly in expensive PACS equipment. PACS is connected to an interface engine and receives orders for diagnostic studies. The interface engine is a software application that governs the translation and exchange of information between the HIS, often referred to as a gateway, and the application may run as a system shared task or have a dedicated platform. It then matches the received orders to image sets coming into the PACS from the digital modalities and radiologic equipment such as x-rays, ultrasound, CT, MR and NM scanning devices by means of a digital imaging communications standard (DICOM). DICOM® is the registered trademark of the National Electrical Manufacturers Association for its standards publications relating to digital communications of medical information. The is a process that ensures that all images are associated with the right patient. To process these order messages successfully, PACS must receive from RIS certain admission, discharge and transfer messages about patients. The PACS also receives electronically assigned reports from the RIS that PACS then archives with the images so that reports and images may be retrieved and displayed concurrently.

Accordingly, what is needed is a way of maintaining the security of patient information being processed by a PACS system by configuring the diagnostic workstation to dynamically set the access permissions for the patient data as well as the mode of display of that data on the image.

### BRIEF SUMMARY OF THE INVENTION

The method and system of the present invention provides a highly customizable and user configurable framework for doing patient de-identification while making it fully compliant with HIPPA requirements. The various DICOM tags that need to be masked or encrypted can be easily configured in the system parameters (which can be stored in any properties file or database) in the central administrative services (CAS) of the healthcare provider.

Whenever the user selects to export any image outside PACS, the CAS is looked for to check if the system forces de-identification or gives the user the choice for de-identification. If the de-identification needs to be done forcefully, then all the configured DICOM tags are extracted from the CAS and stored in the application for performance enhancement. The application then applies the extracted logic while exporting all the selected images and masks all DICOM tags listed in the CAS to be masked.

If the system does not enforce de-identification, then the CAS returns only the list of the DICOM tags to be exported, which are then cached in the application for performance purposes. The user is then prompted to do patient de-identification manually and is also prompted for the choice of the masking for the selected DICOM tags. The images are then exported, which can be saved to hard disk or e-mail, etc., by masking the listed DICOM tags and keeping the rest of the DICOM tags as if they are on the exported image (in any format).

One advantage of the method and system of the present invention is that the user configurable patient de-identification maintains patient confidentiality and meets HIPAA requirements. Another advantage is the configurable “type of masking” feature. That is, the masking can either be hiding the data with any “user defined customizable masking value” or any “system configured encrypting algorithm.” Yet another advantage is that the masking values can have the masking algorithms attached to them which can be easily configured based on the customer's preferences.

The foregoing and other features of the method and system of the present invention will be further apparent from the detailed description that follows.

### BRIEF DESCRIPTION OF THE DRAWINGS

FIG. 1 is a schematic diagram illustrating the interaction between various PACS subsystems of the method and system of the present invention.

FIG. 2 is an exemplary radiographic image display that includes certain patient information as part of the display.

FIG. 3 is the image display of FIG. 2 and showing a patient de-identification cue as part of the display.

FIG. 4 is the image display of FIGS. 2 and 3 and showing the patient information as having been replaced with asterisks in the display.

### DETAILED DESCRIPTION OF THE INVENTION

The following detailed description presupposes that a typical PACS installation exists as previously described.

As previously alluded to, the method and system of the present invention provides a highly customizable and user configurable framework for doing patient de-identification while making it fully compliant with HIPPA requirements. The various DICOM tags that need to be masked or encrypted can be easily configured in the system parameters (which can be stored in any properties file or database) in the CAS of the healthcare provider.

Whenever the user selects to export any image outside PACS, which is the first step, the CAS is looked for to check if the system forces de-identification or gives the user the choice for de-identification. If the de-identification needs to be done forcefully, then all the configured DICOM tags are extracted from the CAS, the second step, and stored in the application, the third step, for performance enhancement. The application then applies the extracted logic while exporting all the selected images and masks all DICOM tags listed in the CAS to be masked. This is the fourth step.

If the system does not enforce de-identification, then the CAS returns only the list of the DICOM tags to be exported, which are then cached in the application for performance purposes. The user is then prompted to do patient de-identification manually and is also prompted for the choice of the masking for the selected DICOM tags. The images are then exported, which can be saved to hard disk or e-mail, etc., by masking the listed DICOM tags and keeping the rest of the DICOM tags as if they are on the exported image (in any format).

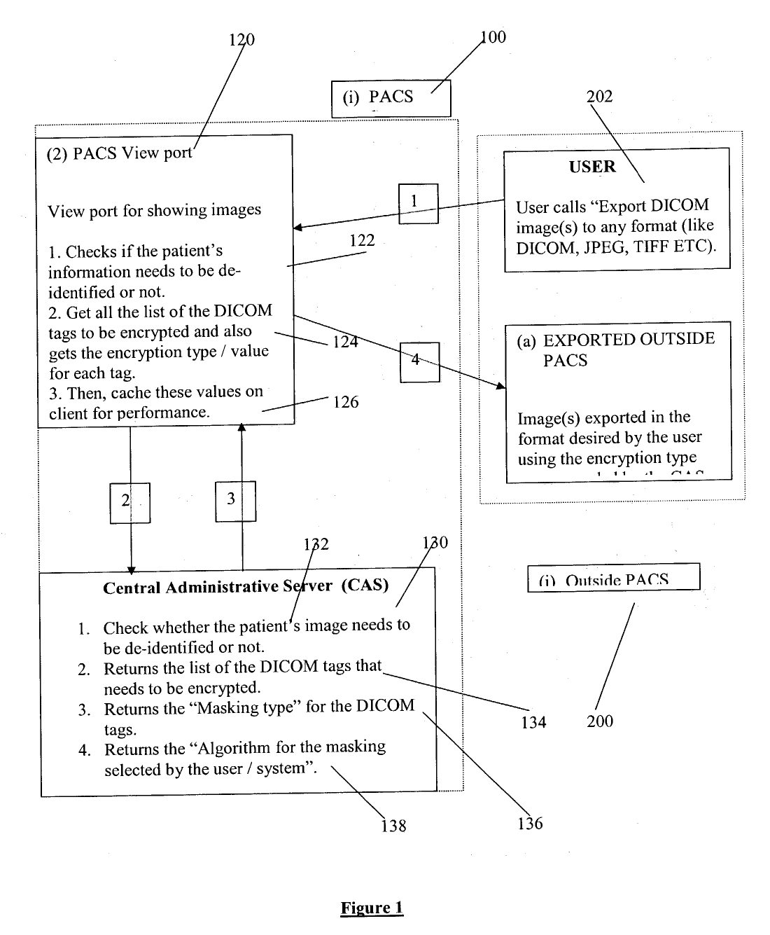

Referring now to the drawings in detail, FIG. 1 schematically represents a PACS system, generally identified 100, with which the method and system of the present invention is utilized. An outside PACS system, generally identified 200, is also schematically represented. The PACS system 100 includes a PACS view port 120 for showing images and a Central Administrative Server (CAS) 130. The outside PACS 200 schematic includes a user step 202 and an exported outside PACS step 204.

In the method and system of the present invention, a user 202 calls “export DICOM images” to any format (such as DICOM, jpeg, tiff, etc.). The view port 120 for showing images interacts with the PACS server to first check 122 to see if the patient's information needs de-identified or not. Next, the PACS server gets 124 the list of the DICOM tags (such as patient name, age, sex, etc.) to be encrypted and also gets the encryption type/value for each tag. Then, these values are cached 126 on the client for performance. During this process, the CAS 130 checks 132 whether the patient's image needs to be de-identified or not. It then returns 134 the list of the DICOM tags that need to be encrypted and returns 136 the “masking type” for the DICOM tags. It then returns 138 the algorithm for the masking selected by the user or by the system. The image or images are then exported 204 in the format desired by the user using the encryption type recommended by the CAS. All of the patient's key information is encrypted to de-identify the patient.

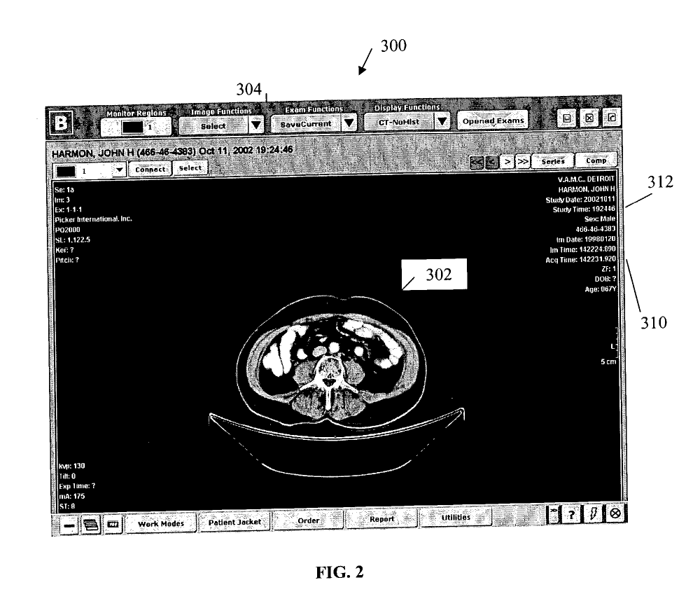

To obtain a visual realization of this functionality, the inventors refer now to FIGS. 2 through 4 wherein a radiographic image display, generally identified 300, is shown. As shown in FIG. 2, the image display 300 includes, in relevant part, an anatomical display 302, a header with certain programming functions 304 and a field of certain information 310 that pertains to the patient who is the subject of the radiographic study. For purposes of the method of the present invention, the precise type of anatomical display 302 is not a limitation of this invention. Nor is the precise type of header 304 or the type of patient information 312 contained within the field 310 that is obtained and displayed a limitation of this invention. The only requirement is that the specific patient information 312 displayed within the field 310 be of the type that is subject to confidential treatment and handling, and further restricted from disclosure to third parties. In the exemplary display 302 that is illustrated in FIG. 2, the patient information 312 included in the field 310 is the patient's name, Social Security identification number, age, sex and date that the study or examination was made. This specific patient information 312 is shown as a field 310 that overlays the anatomical image 302 that is displayed. That information 312 will accompany the image 302 for later use by the patient's health care providers upon receipt of the anatomical image 302.

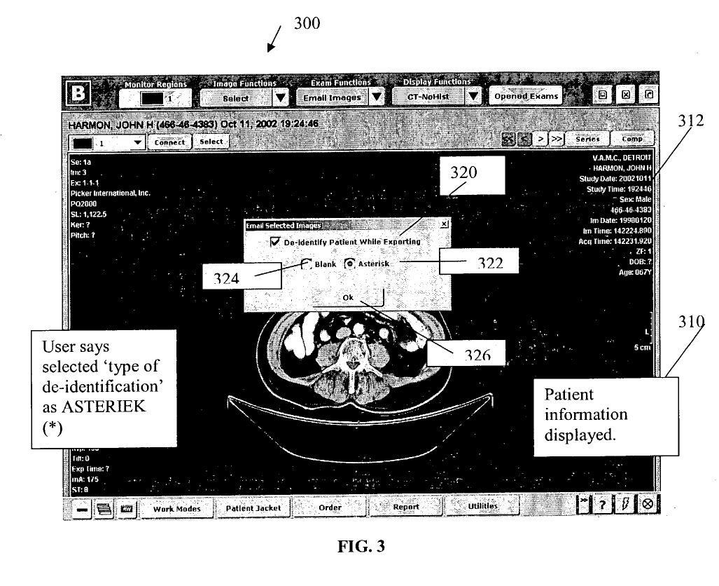

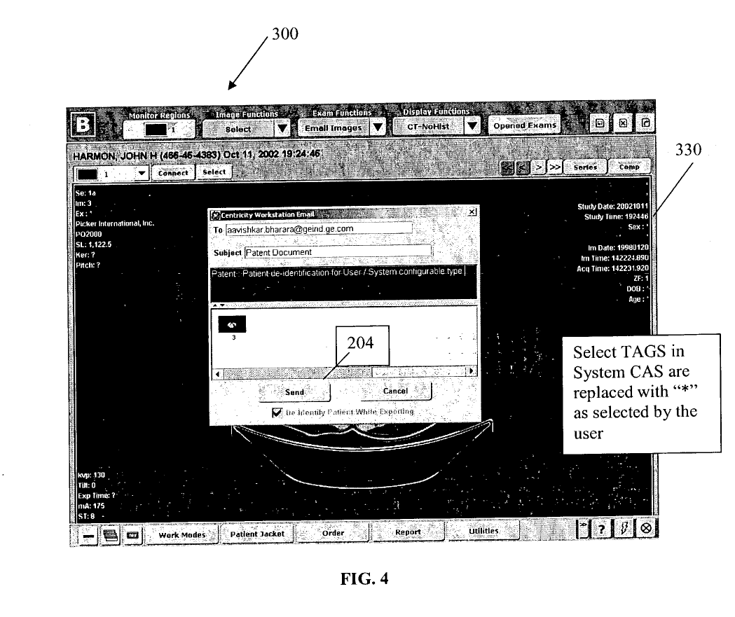

Referring now to FIG. 3, which generally illustrates the same visual display 300 and patient information 312 and field 310, the display 300 also provides the user with a visual cue or prompt 320 prior to export. As shown, the prompt 320 is asking the user to choose de-identification of the confidential patient information 310 during exportation. The prompt 320, as shown, provides an option to the user for inserting either an asterisk 322 or a “blank” 324 where certain of the patient information 312 is displayed. The user clicks “OK” 326 to select the appropriate option and enter the de-identification process. Upon exportation of the image 300, which includes the export of the anatomical image 302 and the patient information 312, selected tags (such as the patient's name, Social Security identification number, age and sex) in the system CAS 130 of the patient information field 312 are replaced in the final field 330 with asterisks 332 at each of the tags as selected by the user. See FIG. 4. Were the user to choose the “blank” 324 option referred to earlier, the patient information 312 in the final field 330 would instead be blank. In this fashion, the patient information 312 contained in the original field 310 is secure and inaccessible during electronic transport and transmission as shown in the final field 330.

Based on the foregoing, it will be seen that the method and system of the present invention provides a highly customizable and user configurable framework for doing patient de-identification while making it fully compliant with HIPPA requirements. The various DICOM tags that need to be masked or encrypted can be easily configured in the system parameters (which can be stored in any properties file or database) in the central administrative services (CAS) of the healthcare provider. Whenever the user selects to export any image outside PACS, the CAS is looked for to check if the system forces de-identification or gives the user the choice for de-identification. If the de-identification needs to be done forcefully, then all the configured DICOM tags are extracted from the CAS and stored in the application for performance enhancement. The application then applies the extracted logic while exporting all the selected images and masks all DICOM tags listed in the CAS to be masked. If the system does not enforce de-identification, then the CAS returns only the list of the DICOM tags to be exported, which are then cached in the application for performance purposes. The user is then prompted to do patient de-identification manually and is also prompted for the choice of the masking for the selected DICOM tags. The images are then exported, which can be saved to hard disk or e-mail, etc., by masking the listed DICOM tags and keeping the rest of the DICOM tags as if they are on the exported image, in any format.

### Parts List:

100 picture archiving and communication system (PACS)

120 PACS view port

122 check to see if de-identification is required

124 PACS server obtains list of DICOM tags to be encrypted

126 caching of values

130 central administrative system (CAS)

132 checking by CAS

134 list returned by CAS

136 masking type for the DICOM tags returned

200 outside PACS

202 user step of outside PACS

204 exported outside PACS step

300 radiographic image display

302 anatomical display

304 display header

310 field of patient information

312 patient information

320 visual cue or prompt prior to export

322 asterisk option

324 blank option

326 OK select

330 final field of patient information

332 final asterisks

What is claimed is:

1. A method for the dynamic configuration of patient tags and masking types for de-identifying patient data during image export from a picture archiving and communication system diagnostic workstation comprising the steps of
providing a picture archiving and communication system,
providing a central administrative server,
using the picture archiving and communication system and the central administrative server to determine if the patient data needs to be de-identified, and
de-identifying the patient data prior to image export.

2. The method of claim 1 including, prior to the de-identification determining step, the step of obtaining a list of DICOM tags to be encrypted.

3. The method of claim 2 including, prior to the de-identification determining step, the step of obtaining the encryption type or value for each tag.

4. The method of claim 3 wherein the DICOM tag obtaining step includes the step of returning the list of the DICOM tags that need to be encrypted from the central administrative server to a view port at the workstation.

5. The method of claim 4 wherein the DICOM tag obtaining step further includes the step of returning the masking type for the DICOM tags to a view port at the workstation.

6. The method of claim 5 wherein the DICOM tag returning step further includes the step of returning the algorithm for the masking selected by the user or the system from the central administrative server to a viewport at the workstation.

7. The method of claim 2 wherein the DICOM tags could include the patient's name, age, sex, or any other confidential patient information.

8. A method for the dynamic configuration of patient tags and masking types for de-identifying patient data during image export from a picture archiving and communication system (PACS) diagnostic workstation comprising the steps of
providing a PACS,
providing a central administrative server (CAS),
obtaining a list of DICOM tags to be encrypted,
using the PACS and the CAS to determine if the patient data needs to be de-identified, and
de-identifying the patient data prior to image export.

9. The method of claim 8 including, prior to the de-identification determining step, the step of obtaining the encryption type or value for each tag.

10. The method of claim 9 wherein the DICOM tag obtaining step includes the step of returning the list of the DICOM tags that need to be encrypted from the central administrative server to a view port.

11. The method of claim 10 wherein the DICOM tag obtaining step further includes the step of returning the masking type for the DICOM tags to a view port.

12. The method of claim 11 wherein the DICOM tag returning step further includes the step of returning the algorithm for the masking selected by the user or the system from the central administrative server.

13. The method of claim 9 wherein the DICOM tags could include the patient's name, age, sex, or any other confidential patient information.

14. A method for performing patient de-identification prior to the export of an image outside of a PACS by a user which comprises the steps of
looking at the CAS to determine if the system forces de-identification or gives the user a choice for de-identification,
extracting all of the configured DICOM tags from the CAS and storing them in the application if de-identification is done forceably,
returning the list of DICOM tags to be exported if de-identification is not done forceably,
applying extracted logic to mask all DICOM tags listed in the CAS to be masked if de-identification is done forceably,
prompting the user to perform patient de-identification manually and prompting the user for the choice of the masking for selected DICOM tags if de-identification is not done forceably, and
exporting all selected images.

15. A system for the dynamic configuration of patient tags and masking types for de-identifying patient data during image export from a picture archiving and communication system diagnostic workstation which comprises
a picture archiving and communication system,
a central administrative server,
means for using the picture archiving and communication system and the central administrative server to determine if the patient data needs to be de-identified, and
means for de-identifying the patient data prior to image export.

16. The system of claim 15 including means for obtaining a list of DICOM tags to be encrypted.

17. The system of claim 16 including means for obtaining the encryption type or value for each tag.

18. The system of claim 17 wherein the DICOM tag obtaining means includes means for returning the list of the DICOM tags that need to be encrypted from the central administrative server to a view port at the workstation.

19. The system of claim 18 wherein the DICOM tag obtaining means further includes means for returning the masking type for the DICOM tags to a view port at the workstation.

20. The system of claim 19 wherein the DICOM tag returning means further includes means for returning the algorithm for the masking selected by the user or the system from the central administrative server to a viewport at the workstation.

21. The system of claim 16 wherein the DICOM tags could include the patient's name, age, sex, or any other confidential patient information.

22. A system for the dynamic configuration of patient tags and masking types for de-identifying patient data during image export from a picture archiving and communication system (PACS) diagnostic workstation which comprises
a PACS,
a central administrative server (CAS),
a list of DICOM tags to be encrypted,
means for using the PACS and the CAS to determine if the patient data needs to be de-identified, and
means for de-identifying the patient data prior to image export.

23. The system of claim 22 including means for obtaining the encryption type or value for each tag.

24. The system of claim 23 wherein the DICOM tag obtaining means includes means for returning the list of the DICOM tags that need to be encrypted from the central administrative server to a view port.

25. The system of claim 24 wherein the DICOM tag obtaining means further includes means for returning the masking type for the DICOM tags to a view port.

26. The system of claim 23 wherein the DICOM tag returning means further includes means for returning the algorithm for the masking selected by the user or the system from the central administrative server.

27. The system of claim 23 wherein the DICOM tags could include the patient's name, age, sex, or any other confidential patient information.

28. A system for performing patient de-identification prior to the export of an image outside of a PACS by a user which comprises
means for looking at the CAS to determine if the system forces de-identification or gives the user a choice for de-identification,
means for extracting all of the configured DICOM tags from the CAS and storing them in the application if de-identification is done forceably,
means for returning the list of DICOM tags to be exported if de-identification is not done forceably,
means for applying extracted logic to mask all DICOM tags listed in the CAS to be masked if de-identification is done forceably,
means for prompting the user to perform patient de-identification manually and prompting the user for the choice of the masking for selected DICOM tags if de-identification is not done forceably, and
means for exporting all selected images.
